(19) United States
(12) Patent Application Publication
(10) Pub. No.: US 2005/0206719 A1
(43) Pub. Date: Sep. 22, 2005

(54) Image forming apparatus

(75) Inventors: Kenichi Komiya, Kawasaki-shi (JP); Koji Tanimoto, Tagata-gun (JP); Daisuke Ishikawa, Sunto-gun (JP); Yuji Inagawa, Numazu-shi (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/805,306

(22) Filed: Mar. 22, 2004

(51) Int. Cl. B41J 2/435

(52) U.S. Cl. 347/248

(57) ABSTRACT

An image forming apparatus according to an embodiment of this invention includes a light emission unit for emitting a light beam, a scanning control unit for controlling scanning of the light beam, a first light emission control unit for controlling the light emission timing of the light emission unit on the basis of a reference clock, a second light emission control unit for controlling the light emission timing of the light emission unit in correspondence with image data of one line in the main scanning direction on the basis of the generation timing of a horizontal sync signal, and an image forming unit for forming an image on the basis of the light beam.

### BACKGROUND OF THE INVENTION

1. Field of the Invention

The present invention relates to an image forming apparatus which scans, on a photosensitive drum, a light beam based on image data to form an image.

2. Description of the Related Art

An image forming apparatus such as a copying machine comprises a semiconductor laser oscillator, a polygon mirror formed from a polyhedron, a photosensitive drum, and the like. The semiconductor laser oscillator emits a light beam corresponding to image data on the basis of light emission control based on the image data. The polygon mirror is rotated by a polygon motor at a predetermined speed. The polygon mirror reflects the light beam emitted from the semiconductor laser oscillator to scan the surface of the photosensitive drum with the light beam. By scanning with the light beam, an electrostatic latent image corresponding to the image data is formed on the photosensitive drum. The electrostatic latent image formed on the photosensitive drum is developed and transferred to a paper sheet.

For example, when the rotational speed of the polygon mirror is changed, the resolution in the sub-scanning direction can be controlled. However, since the polygon mirror rotates at an ultrahigh speed, it is not easy to control it at a plurality of different speeds, resulting in an increase in cost.

To solve this problem, for example, Jpn. Pat. Appln. KOKAI Publication No. 04-247418 discloses a technique. In this prior art, in synchronism with rotation of each surface of a polygon mirror, a rotation sync signal is output from an encoder which monitors the rotation of the polygon mirror. The number of pulses of the rotation sync signal is counted. By monitoring the count value, the laser emission timing is controlled. More specifically, instead of reflecting a light beam by using all reflection surfaces of the polygon mirror, the light beam is reflected by using a predetermined reflection surface.

To do this, however, alignment between the reflection surfaces of the polygon mirror and the encoder is necessary. Adjustment for this alignment is time-consuming and also leads to an increase in cost.

### BRIEF SUMMARY OF THE INVENTION

It is an object of the present invention to provide an image forming apparatus capable of executing interlaced scanning without any complex control or adjustment.

According to an aspect of the present invention, there is provided an image forming apparatus comprising light emission means for emitting a light beam, scanning control means for controlling scanning of the light beam emitted by the light emission means, first light emission control means for controlling a light emission timing of the light emission means on the basis of a reference clock by a timing prepared in advance, second light emission control means for controlling the light emission timing of the light emission means in correspondence with image data of one line in a main scanning direction on the basis of a generation timing of a horizontal sync signal corresponding to the emission of the light beam under control of the first light emission control means, and image forming means for forming an image on the basis of the light beam scanned under control of the scanning control means in correspondence with the emission of the light beam under control of the second light emission control means.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing the schematic arrangement of a light beam scanning apparatus applied to an image forming apparatus according to an embodiment of the present invention and the positional relationship between the light beam scanning apparatus and a photosensitive drum;

FIG. 2 is a control block diagram showing the schematic arrangement of the image forming apparatus according to the embodiment of the present invention;

FIG. 3 is a block diagram showing the detailed arrangement of a laser control circuit shown in the control block diagram of FIG. 2;

FIG. 4 is a view showing an example of scanning by a light beam in mode 1 (normal scanning) and mode 2 (interlaced scanning);

FIG. 5 is a timing chart showing an introduction routine to an APC routine for synchronizing the polygon mirror rotating at a high speed with the laser emission timing in order to explain mode 1;

FIG. 6 is a timing chart showing a sequence next to the introduction routine shown in FIG. 5 in order to explain mode 1;

FIG. 7 is a timing chart for explaining mode 2;

FIG. 8 is a table showing an example of comparative reference values set in correspondence with mode 1 and mode 2; and

FIG. 9 is a flowchart showing image forming processing in mode 1 and mode 2.

### DETAILED DESCRIPTION OF THE INVENTION

An embodiment of the present invention will be described below with reference to the accompanying drawing.

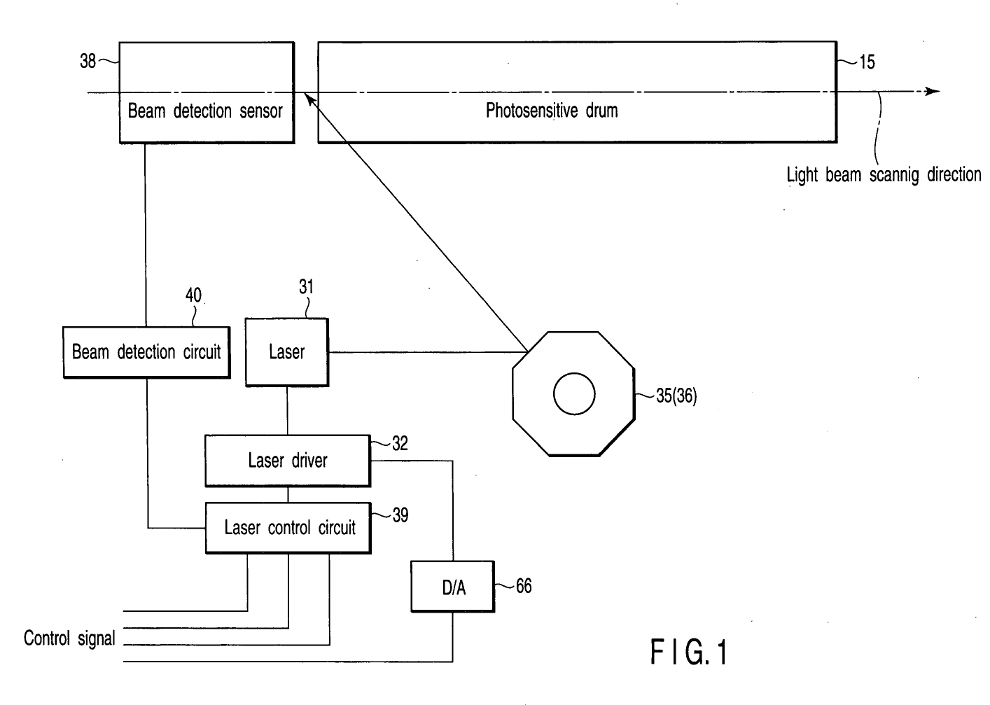

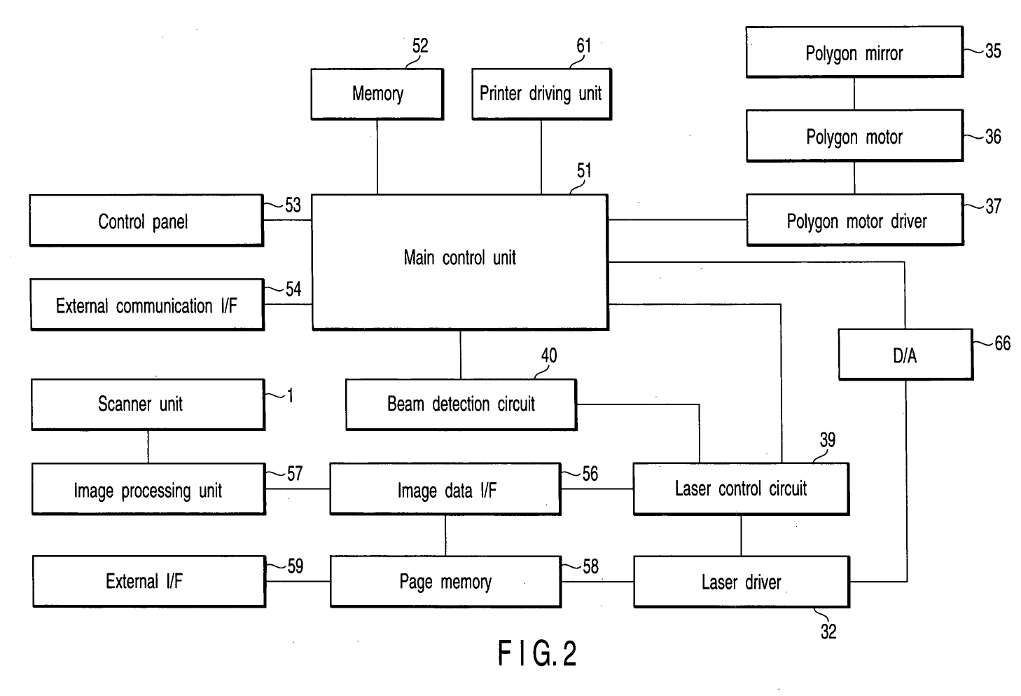

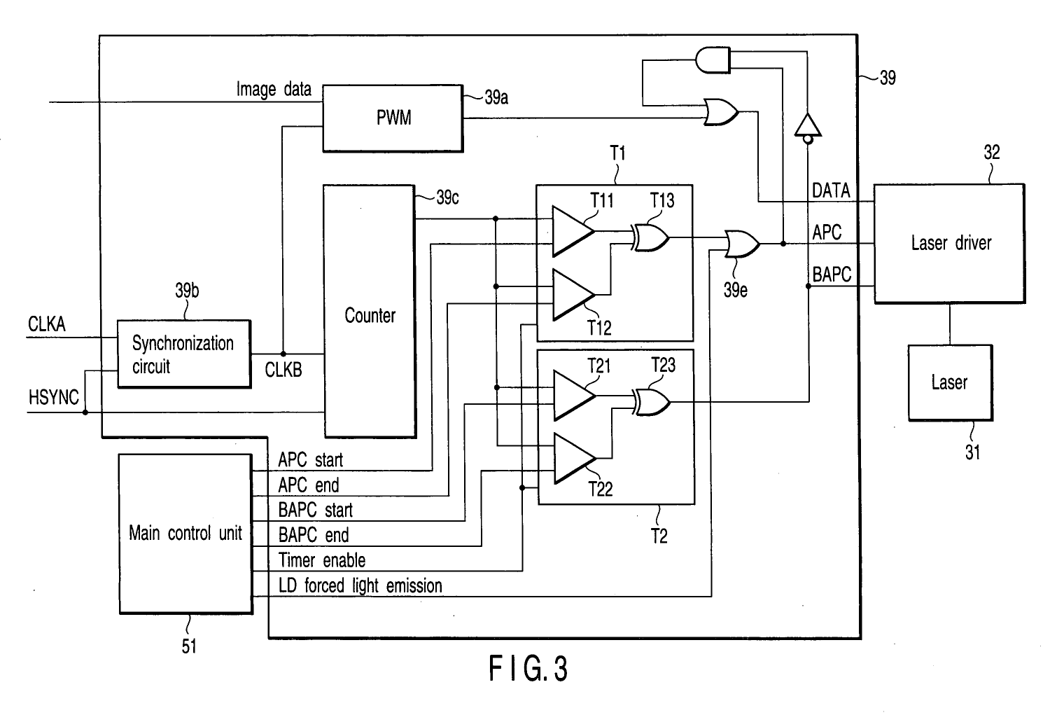

FIG. 1 is a view showing the schematic arrangement of a light beam scanning apparatus applied to an image forming apparatus according to the embodiment of the present invention and the positional relationship between the light beam scanning apparatus and a photosensitive drum. FIG. 2 is a control block diagram showing the schematic arrangement of the image forming apparatus according to the embodiment of the present invention. FIG. 3 is a block diagram showing the detailed arrangement of a laser control circuit shown in the control block diagram of FIG. 2.

As shown in FIG. 1, the light beam scanning apparatus incorporates a laser oscillator 31 serving as a light emission means. The laser oscillator 31 forms an image for each scanning line. The laser oscillator 31 is driven by a laser driver 32 serving as first and second light-emission control means. An output light beam passes through a collimator lens and a half mirror and then becomes incident on a polygon mirror 35 serving as a polygon rotating mirror.

As shown in FIGS. 1 and 2, the polygon mirror 35 serving as a scanning control means is rotated at a predetermined speed by a polygon motor 36 driven by a polygon motor driver 37. Accordingly, the reflected light from the polygon mirror 35 is scanned in a predetermined direction at an angular speed defined by the rotational speed of the polygon motor 36. The light beam scanned by the polygon mirror 35 passes through an f-θ lens which converts the uniform angular motion of the light beam into uniform linear motion. The light beam that has passed through the f-θ lens scans the light-receiving surface of a beam detection sensor 38 and the surface of a photosensitive drum 15 serving as an image carrier at a predetermined speed.

The laser driver 32 serving as a light amount control means incorporates an auto power control (APC) circuit. The laser driver 32 causes the laser oscillator 31 to emit light at a light emission power level set from a main control unit (CPU) 51 (to be described later).

The beam detection sensor 38 serving as a light amount detection means detects the passage position, passage timing, and power of the light beam. The beam detection sensor 38 is disposed near the end portion of the photosensitive drum 15 while aligning the light-receiving surface with the surface of the photosensitive drum 15. The sensor signal from the beam detection sensor 38 is input to a beam detection circuit 40. The beam detection circuit 40 detects the passage position, passage timing, and power of the light beam on the basis of the sensor signal from the beam detection sensor 38. On the basis of the detection result from the beam detection circuit 40, the light emission power (intensity) control and light emission timing control (image forming position control in the main scanning direction) of the laser oscillator 31 are executed (to be described later in detail). The beam detection circuit 40 also outputs a horizontal sync signal (HSYNC) on the basis of detection of the passage timing of the light beam.

As shown in FIG. 2, the main control unit 51 executes overall control and includes, e.g. a CPU. The laser driver 32, polygon mirror motor driver 37, beam detection circuit 40, and printer driving unit 61 are connected to the main control unit 51 through a memory 52, control panel 53, external communication interface (I/F) 54, and D/A converter 66.

The flow of image data in forming an image will briefly be described below.

In a copy operation, the image of an original is read by a scanner unit 1 and sent to an image processing unit 57. The image processing unit 57 executes predetermined processing for the image signal from the scanner unit 1. The image data from the image processing unit 57 is sent to a laser control circuit 39 through an image data I/F 56.

The control panel 53 is a man-machine interface which activates the copy operation or sets the number of copies. Mode 1 or mode 2 (to be described later) is set through the control panel 53.

This digital copying machine is designed to be able to form and output even image data externally input through an external I/F 59 connected to a page memory 58 in addition to the copy operation.

When the digital copying machine is externally controlled through, e.g., a network, the external communication I/F 54 functions as the control panel 53.

The polygon motor driver 37 is a driver which drives the polygon motor 36 to rotate the polygon mirror 35 which scans the light beam. The main control unit 51 executes rotation start control and rotation stop control for the polygon motor driver 37.

The memory 52 stores information necessary for control. For example, when a circuit characteristic (the offset value of an amplifier) necessary for detecting the passage position of a light beam and print area information corresponding to a light beam are stored, the light beam scanning apparatus can immediately be set in an image formation enable state after power-on.

APC will be described next. The main control unit 51 supplies an APC start signal, APC end signal, BAPC start signal, BAPC end signal, timer enable signal, and forced light emission signal to the laser control circuit 39. On the basis of the supplied signals, the laser control circuit 39 controls forced light beam emission at a predetermined timing outside the control period (outside the image area) of the light beam emission timing based on image data. On the basis of a light emission detection result detected in correspondence with the forced light emission, the main control unit 51 outputs a light amount control signal that controls the amount of the light beam emitted from the laser oscillator 31 to a predetermined value. The laser control circuit 39 controls the light amount of the laser oscillator 31 on the basis of the light amount control signal output from the main control unit.

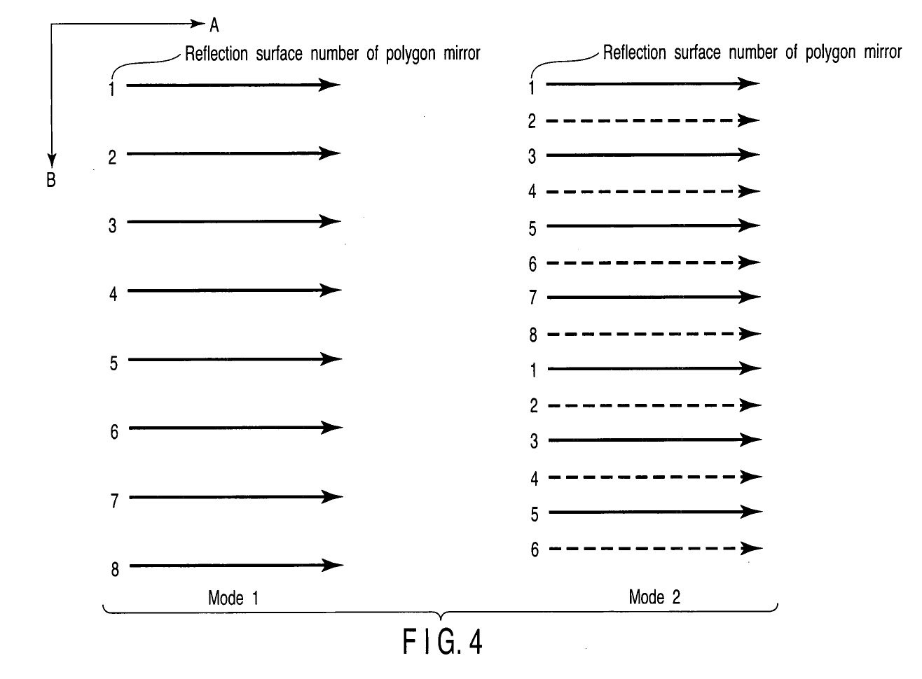

Interlaced scanning by the above-described image forming apparatus will be described next. FIG. 4 is a view showing an example of scanning by a light beam in mode 1 and mode 2. Mode 1 is employed in printing on, e.g., a normal paper sheet. Mode 2 is employed in printing on, e.g., a cardboard.

For example, assume that the above-described polygon mirror 35 is a rotating mirror made of an octahedron. That is, the polygon mirror 35 has eight reflection surfaces. Numbers added on the left sides of arrows in FIG. 4 are numbers to identify the reflection surfaces of the polygon mirror 35. Each arrow corresponding to a number indicates an image line formed by a light beam reflected by a reflection surface having that number. An arrow A in FIG. 4 indicates the main scanning direction. An arrow B indicates the sub-scanning direction.

In mode 1, an image having a resolution of 600 dpi is formed at a process speed (an image convey speed in the sub-scanning direction) VP and a scanning speed (a speed at which the beam is scanned in the main scanning direction) Vs. In mode 1, an image is formed by a light beam which is sequentially reflected by all the reflection surfaces of the polygon mirror 35.

In mode 2, the reflection surfaces of the polygon mirror 35 are alternately used, and an image is formed by a light beam reflected by these reflection surfaces. For example, in mode 2 shown in FIG. 4, an image is formed by a light beam reflected by the odd-numbered surfaces of the polygon mirror 35.

An image printed on a cardboard requires a longer time until fixing than an image printed on a normal paper sheet. For this reason, the process speed as the image convey speed in the sub-scanning direction is reduced to ½. That is, the image forming operation is performed at ½ VP. When the process speed is reduced to ½, and accordingly, the rotational speed of the polygon motor is also reduced to ½, image formation can be executed by the same operation as in mode 1. Since the polygon motor rotates at an ultrahigh speed, it is not easy to control it at a plurality of different speeds, resulting in an increase in cost. However, if an image is formed by using all the reflection surfaces of the polygon mirror while reducing the process speed to ½ but without reducing the rotational speed of the polygon motor to ½, lines in mode 2, which are indicted by broken lines in FIG. 4, are also scanned. Accordingly, the resolution in the sub-scanning direction increases to twice. By using this fact, the resolution in the sub-scanning direction can be increased from 600 dpi to 1,200 dpi.

If printing on a cardboard should simply be executed without changing the resolution in the sub-scanning direction, it is necessary to reduce the process speed to ½ and even the scanning speed to ½. However, speed control for the polygon motor has the problem of an increase in cost. To solve this problem, the image forming apparatus according to the present invention can execute mode 2 for mode 1 while keeping the polygon motor rotational speed fixed. That is, in mode 2, the rotational speed of the polygon motor 36 is fixed. The reflection surfaces of the polygon mirror 35 are alternately used. An image is formed by a light beam reflected by these reflection surfaces. That is, in mode 1, a light beam is reflected by using all the reflection surfaces of the polygon mirror 35. In mode 2, a light beam is reflected by alternately using the reflection surfaces of the polygon mirror 35. Accordingly, in mode 1, an 8-line image is formed in correspondence with one revolution of the polygon mirror 35. In mode 2, a 4-line image is formed in correspondence with one revolution of the polygon mirror 35. Hence, printing on a cardboard can appropriately be executed at the same resolution (600 dpi) as in mode 1 by reducing the process speed to ½ without changing the rotational speed of the polygon motor 36.

Interlaced scanning control to simplify control of interlaced scanning in mode 2 will be described next. There is an interlaced scanning method using an encoder which monitors the rotation of the polygon mirror. That is, the number of pulses of a rotation sync signal output in synchronism with the rotation of each surface of the polygon mirror from the encoder which monitors the rotation of the polygon mirror is counted. By monitoring the count value, the laser emission timing is controlled. However, in this method, alignment between the reflection surfaces of the polygon mirror and the encoder is necessary. Adjustment for this alignment is time-consuming and also leads to an increase in cost.

In the image forming apparatus according to this embodiment, the laser emission timing is adjusted by using a horizontal sync signal and an image clock, thereby executing interlaced scanning using only desired reflection surfaces of the polygon mirror 35. With this arrangement, reliable interlaced scanning can be executed by simple control without using any encoder. Interlaced scanning using only desired reflection surfaces of the polygon mirror 35 is implemented by the laser control circuit 39.

As shown in FIG. 3, the laser control circuit 39 comprises a PWM (Pulse Width Modulator) 39a, synchronization circuit 39b, counter 39c, timers T1 and T2, and OR gate 39e. A reference clock (CLKA) and horizontal sync signal (HSYNC) are input to the synchronization circuit 39b. The synchronization circuit 39b outputs an image clock (CLKB) synchronized with the horizontal sync signal (HSYNC) on the basis of the reference clock (CLKA). The image data and image clock (CLKB) are input to the PWM 39a. The PWM 39a outputs as a laser modulation signal image data synchronized with the image clock (CLKB). The laser driver 32 controls the light emission timing of the laser oscillator 31 on the basis of the laser modulation signal. When the image data is transferred in synchronism with scanning of the light beam in this way, a latent image is formed on the photosensitive drum 15 in synchronization (at a correct position) in the main scanning direction. The printer driving unit 61 forms a print image on a predetermined paper sheet on the basis of the latent image on the photosensitive drum 15.

The image clock (CLKB) synchronized with the horizontal sync signal (HSYNC) and the horizontal sync signal (HSYNC) are input to the counter 39c. The counter 39c counts the image clock (CLKB) and also clears the count value of the image clock (CLKB) in accordance with the horizontal sync signal (HSYNC).

The timer T1 functions for APC to forcibly cause the laser oscillator 31 to emit light in a non-image region and control the power of the light beam. In other words, the timer T1 has a function of preventing the photosensitive drum 15 from being irradiated and developed with the light beam emitted by forced light emission for APC execution. On the other hand, the timer T2 functions to apply a bias current to the laser oscillator 31 at a predetermined timing to execute APC at a predetermined timing.

The output (count value) from the counter 39c is connected to the timers T1 and T2. The counter 39c has a counter capacity enough to count the image clock (CLKB) for the HSYNC period. For example, in alternate interlaced scanning using four of the eight reflection surfaces of the polygon mirror 35, the counter 39c has a counter capacity enough to count the image clock for HSYNC period×2 (T2) or more.

The timer T1 incorporates comparators T11 and T12 and an EXOR circuit T13. The output from the comparator T11 is connected to one terminal of the EXOR circuit T13, and the output from the comparator T12 is connected to the other terminal of the EXOR circuit T13. The output from the EXOR circuit T13 is the output from the timer T1. The timer T1 also has an enable terminal that receives a timer enable signal output from the main control unit 51. When a timer enable signal of low level is input through the enable terminal, the output from the timer T1 is fixed to low level. That is, to use the timer T1, a timer enable signal of high level is input to the enable terminal.

The output (count value) from the counter 39c is input to one input terminal of the comparator T11. A comparative reference value (APC start signal) from the main control unit 51 is input to the other input terminal of the comparator T11. The comparator T11 compares the count value from the counter 39c with the comparative reference value set by the main control unit 51. When the count value is smaller than the comparative reference value, the comparator T11 outputs a low-level signal. Conversely, when the count value is larger than the comparative reference value, the comparator T11 outputs a high-level signal. The output (count value) from the counter 39c is input to one input terminal of the comparator T12. A comparative reference value (APC end signal) from the main control unit 51 is input to the other input terminal of the comparator T12. The comparator T12 compares the count value from the counter 39c with the comparative reference value set by the main control unit 51. When the count value is smaller than the comparative reference value, the comparator T12 outputs a low-level signal. Conversely, when the count value is larger than the comparative reference value, the comparator T12 outputs a high-level signal.

The outputs from the comparators T11 and T12 are connected to the EXOR circuit T13. For example, m is set as the comparative reference value for the comparator T11, and n (m<n) is set as the comparative reference value for the comparator T12. In this case, the timer T1 outputs a timer signal (APC signal) of high level only in the section from m to n. The timer signal (APC signal) output from the timer T1 is input to the laser driver 32 through the OR gate 39e. When the APC signal is at high level, the laser driver 32 forcibly causes the laser to emit light.

The timer T2 incorporates comparators T21 and T22 and an EXOR circuit T23. The output from the comparator T21 is connected to one terminal of the EXOR circuit T23, and the output from the comparator T22 is connected to the other terminal of the EXOR circuit T23. The output from the EXOR circuit T23 is the output from the timer T2. The timer T2 also has an enable terminal that receives a timer enable signal output from the main control unit 51. When a timer enable signal of low level is input through the enable terminal, the output from the timer T2 is fixed to low level. That is, to use the timer T2, a timer enable signal of high level is input to the enable terminal.

The output (count value) from the counter 39c is input to one input terminal of the comparator T21. A comparative reference value (BAPC start signal) from the main control unit 51 is input to the other input terminal of the comparator T21. The comparator T21 compares the count value from the counter 39c with the comparative reference value set by the main control unit 51. When the count value is smaller than the comparative reference value, the comparator T21 outputs a low-level signal. Conversely, when the count value is larger than the comparative reference value, the comparator T21 outputs a high-level signal. The output (count value) from the counter 39c is input to one input terminal of the comparator T22. A comparative reference value (BAPC end signal) from the main control unit 51 is input to the other input terminal of the comparator T22. The comparator T22 compares the count value from the counter 39c with the comparative reference value set by the main control unit 51. When the count value is smaller than the comparative reference value, the comparator T22 outputs a low-level signal. Conversely, when the count value is larger than the comparative reference value, the comparator T22 outputs a high-level signal.

The outputs from the comparators T21 and T22 are connected to the EXOR circuit T23. For example, m is set as the comparative reference value for the comparator T21, and n (m<n) is set as the comparative reference value for the comparator T22. In this case, the timer T2 outputs a timer signal (BAPC signal) of high level only in the section from m to n. The timer signal (BAPC signal) output from the timer T2 is input to the laser driver 32. When the BAPC signal is at high level, the laser driver 32 applies a bias current to the laser.

With the above arrangement, the image forming apparatus according to the present invention can freely generate an APC signal and BAPC signal between a horizontal sync signal (HSYNC) and the next horizontal sync signal (HSYNC) by counting the image clock (CLKB) synchronized with the horizontal sync signal (HSYNC) and setting predetermined comparative reference values (timings that are prepared in advance) for the timers T1 and T2. As described above, since the APC signal can freely be generated, the generation period of the horizontal sync signal (HSYNC) can freely be controlled, and the light emission timing of the laser oscillator 31 can freely be controlled.

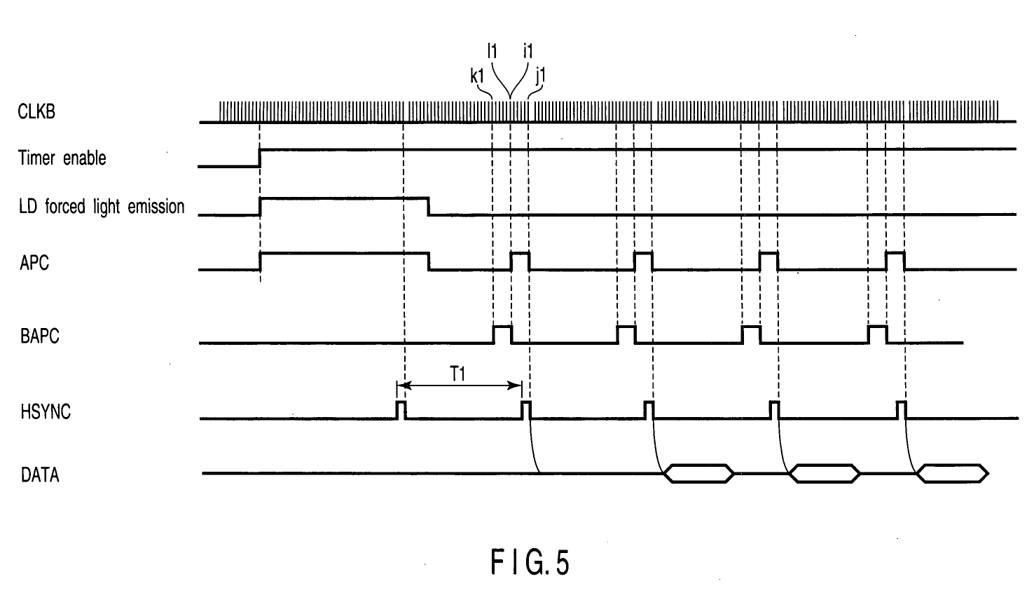

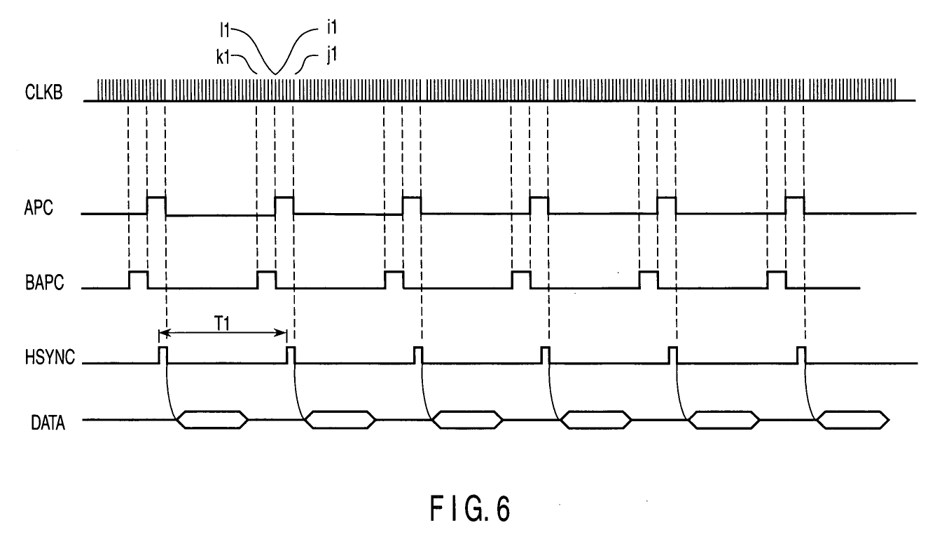

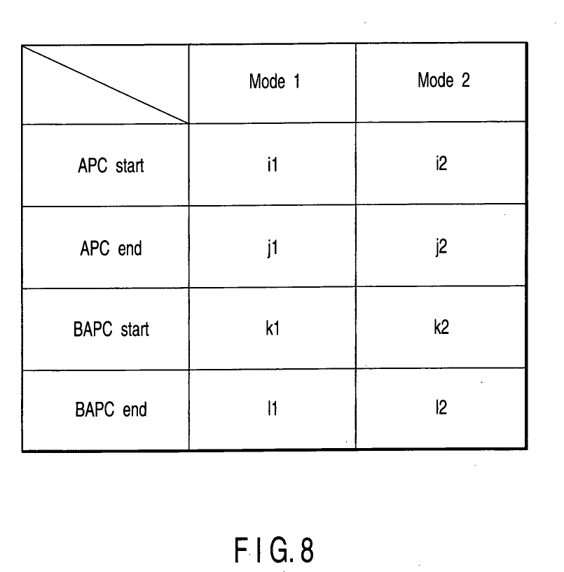

FIGS. 5 and 6 are timing charts for explaining mode 1 (normal printing). As shown in FIG. 8, the main control unit 51 sets comparative reference values i1 and j1 (timings prepared in advance) for the comparators T11 and T12 incorporated in the timer T1 and comparative reference values k1 and l1 (timings prepared in advance) for the comparators T21 and T22 incorporated in the timer T2.

FIG. 5 is a timing chart showing an introduction routine to an APC routine for synchronizing the polygon mirror 35 rotating at a high speed with the laser emission timing. As shown in FIG. 5, the main control unit 51 sets the timer enable signal to high level to make the timers T1 and T2 effective. Simultaneously, the main control unit 51 sets the LD forced light emission signal to high level to forcibly cause the laser to emit light. As shown in FIG. 3, the LD forced light emission signal is input to the laser driver 32 through the OR gate 39e as the APC signal. For this reason, when the LD forced light emission signal changes to high level, the APC signal changes to high level, and the laser oscillator 31 emits light.

The forcibly emitted light beam is scanned as the polygon mirror 35 rotates. Accordingly, when the light beam passes through the beam detection sensor 38, the horizontal sync signal (HSYNC) is generated. When the horizontal sync signal (HSYNC) is generated, the count value of the counter 39c is cleared, counting of the image clock (CLKB) starts, and the laser forced light emission signal changes to low level. When the count operation by the counter 39c starts, the light emission timing of the laser oscillator 31 is controlled by the counter 39c and the settings of the timer T1. For this reason, the normal APC operation shown in FIG. 6 is executed.

As shown in FIG. 6, the count value of the counter 39c is cleared as the horizontal sync signal (HSYNC) is input. The counter 39c counts the image clock (CLKB) output from the synchronization circuit 39b and outputs the count value to the timers T1 and T2. When the count value of the counter 39c reaches k1, the output (BAPC signal) from the timer T2 changes to high level. Until the count value of the counter 39c reaches l1, the output (BAPC signal) from the timer T2 is held at high level. More specifically, in the section where the count value of the counter 39c is k1 to l1, the output (BAPC signal) from the timer T2 is held at high level. While the output (BAPC signal) from the timer T2 is held at high level, the laser driver 32 executes BAPC control.

On the other hand, when the count value of the counter 39c reaches i1, the output (APC signal) from the timer T1 changes to high level. Until the count value of the counter 39c reaches j1, the output (APC signal) from the timer T1 is held at high level. More specifically, in the section where the count value of the counter 39c is i1 to j1, the output (APC signal) from the timer T1 is held at high level. While the output (APC signal) from the timer T1 is held at high level, the laser driver 32 executes APC control.

Under the APC control in the section from i1 to j1, the laser oscillator 31 emits light. In correspondence with the laser emission, the horizontal sync signal (HSYNC) is generated. That is, the generation period of the horizontal sync signal (HSYNC) can be controlled by the set reference values i1, j1, k1, and l1. In this case, the horizontal sync signal (HSYNC) is generated at a period T1. The image data is output as a laser modulation signal synchronized with the image clock (CLKB) synchronized with the horizontal sync signal (HSYNC). An image is formed on the basis of the laser modulation signal.

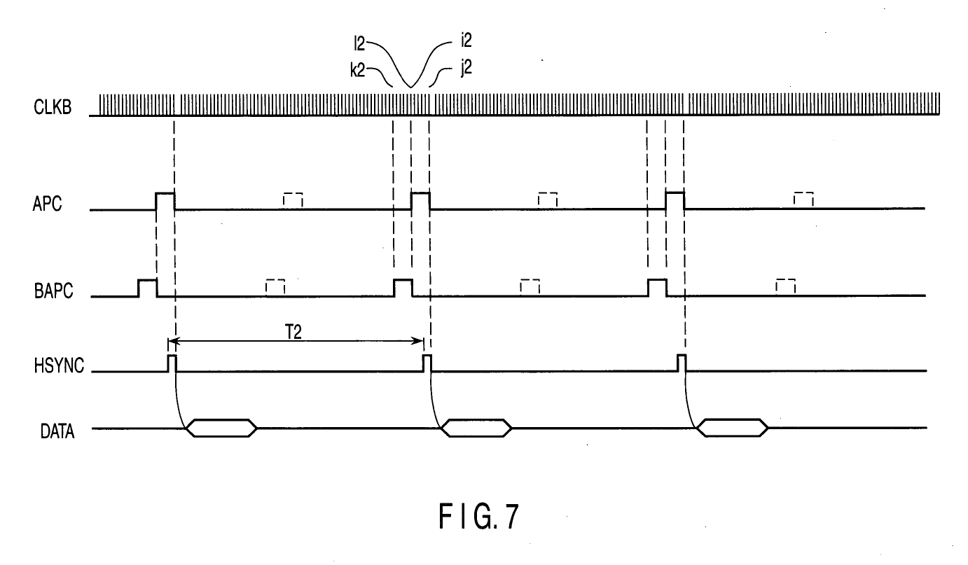

Interlaced scanning will be described next with reference to FIG. 7. In this embodiment, for example, interlaced scanning, i.e., a case wherein a 4-line image is formed in correspondence with one revolution of the polygon mirror 35 having eight reflection surfaces will be described. Even in interlaced scanning shown in FIG. 7, the introduction routine to APC shown in FIG. 5 is executed in advance. As shown in FIG. 8, the main control unit 51 sets comparative reference values i2 and j2 (timings prepared in advance) for the comparators T11 and T12 incorporated in the timer T1 and comparative reference values k2 and l2 (timings prepared in advance) for the comparators T21 and T22 incorporated in the timer T2.

As shown in FIG. 7, the count value of the counter 39c is cleared as the horizontal sync signal (HSYNC) is input. The counter 39c counts the image clock (CLKB) output from the synchronization circuit 39b and outputs the count value to the timers T1 and T2. When the count value of the counter 39c reaches k2, the output (BAPC signal) from the timer T2 changes to high level. Until the count value of the counter 39c reaches l2, the output (BAPC signal) from the timer T2 is held at high level. More specifically, in the section where the count value of the counter 39c is k2 to l2, the output (BAPC signal) from the timer T2 is held at high level. While the output (BAPC signal) from the timer T2 is held at high level, the laser driver 32 executes BAPC control.

On the other hand, when the count value of the counter 39c reaches i2, the output (APC signal) from the timer T1 changes to high level. Until the count value of the counter 39c reaches j2, the output (APC signal) from the timer T1 is held at high level. More specifically, in the section where the count value of the counter 39c is i2 to j2, the output (APC signal) from the timer T1 is held at high level. While the output (APC signal) from the timer T1 is held at high level, the laser driver 32 executes APC control.

Under the APC control in the section from i2 to j2, the laser oscillator 31 emits light. In correspondence with the laser emission, the horizontal sync signal (HSYNC) is generated. That is, the generation period of the horizontal sync signal (HSYNC) can be controlled by the set reference values i2, j2, k2, and l2. In this case, the horizontal sync signal (HSYNC) is generated at a period T2. The image data is output as a laser modulation signal synchronized with the image clock (CLKB) synchronized with the horizontal sync signal (HSYNC). An image is formed on the basis of the laser modulation signal.

As described above, by setting comparative reference values corresponding to each mode, the laser emission timing can easily and accurately be controlled. That is, the laser emission timing can be controlled in correspondence with each image clock. As a result, the rotational speed of the polygon motor need not be controlled to a plurality of speeds (the rotational speed of the polygon motor can be fixed). In addition, without using any encoder that monitors rotation of the polygon mirror, predetermined interlaced scanning can be executed.

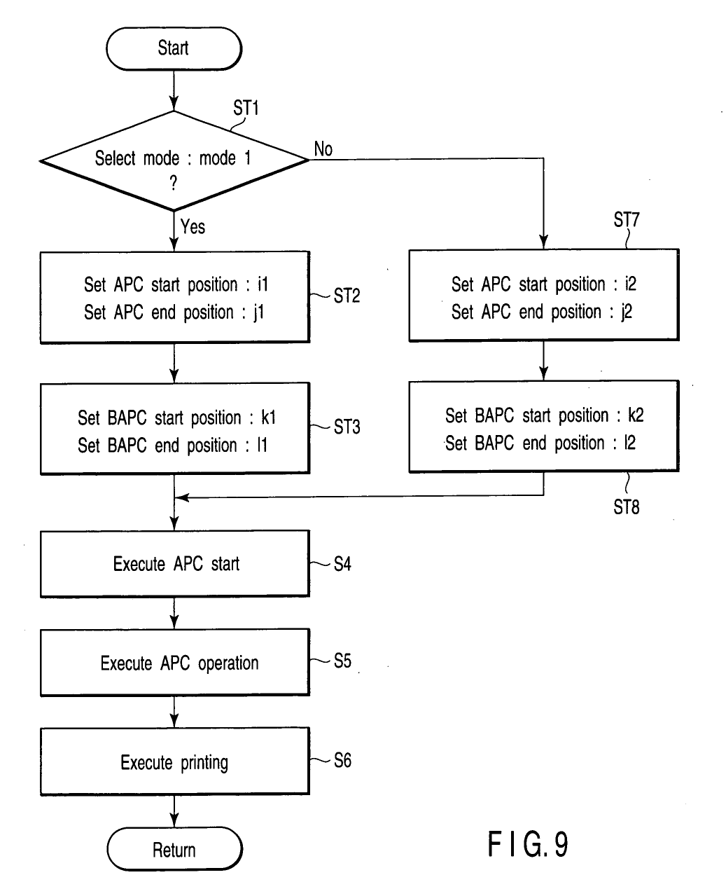

FIG. 9 is a flowchart showing image forming processing in mode 1 and mode 2. For example, when mode 1 is selected through the control panel 53 (YES in ST1), the comparative reference value i1 is set as the APC start position, and the comparative reference value j1 is set as the APC end position (ST2). In addition, the comparative reference value k1 is set as the BAPC start position, and the comparative reference value l1 is set as the BAPC end position (ST3). Subsequently, the APC start timing is adjusted (ST4). The APC start timing adjustment is the introduction routine to the APC routine for synchronizing the polygon mirror 35 rotating at a high speed with the laser emission timing. In accordance with the APC start timing adjustment, the rotation of the polygon mirror 35 is synchronized with the laser emission timing. APC is started (ST5), and image formation (printing) is started (ST6).

When mode 2 is selected through the control panel 53 (NO in ST1), the comparative reference value i2 is set as the APC start position, and the comparative reference value j2 is set as the APC end position (ST7). In addition, the comparative reference value k2 is set as the BAPC start position, and the comparative reference value l2 is set as the BAPC end position (ST8). Subsequently, the APC start timing is adjusted (ST4). APC is started (ST5), and image formation (printing) is started (ST6).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image forming apparatus comprising:
light emission means for emitting a light beam;
scanning control means for controlling scanning of the light beam emitted by the light emission means;
first light emission control means for controlling a light emission timing of the light emission means on the basis of a reference clock by a timing prepared in advance;
second light emission control means for controlling the light emission timing of the light emission means in correspondence with image data of one line in a main scanning direction on the basis of a generation timing of a horizontal sync signal corresponding to the emission of the light beam under control of the first light emission control means; and
image forming means for forming an image on the basis of the light beam scanned under control of the scanning control means in correspondence with the emission of the light beam under control of the second light emission control means.

2. An apparatus according to claim 1, wherein
the image forming means sets a predetermined process speed from a plurality of different process speeds in a sub-scanning direction, and
the first light emission control means sets a predetermined timing, which is prepared in advance, in correspondence with setting of the predetermined process speed, detects the predetermined timing on the basis of the reference clock, and controls the light emission timing of the light emission means.

3. An apparatus according to claim 1, wherein
the image forming means sets a predetermined process speed from a plurality of different process speeds in a sub-scanning direction, and
the first light emission control means sets a predetermined timing, which is prepared in advance, in correspondence with setting of the predetermined process speed, detects the predetermined timing on the basis of an image clock corresponding to the reference clock, and causes the light emission means to emit light at a predetermined period to generate the horizontal sync signal at the predetermined period.

4. An apparatus according to claim 1, wherein
the image forming means selects one of a first process speed and a second process speed in a sub-scanning direction when a latent image formed in correspondence with scanning of the light beam is to be transferred to a predetermined medium, and
the first light emission control means sets a first timing, which is prepared in advance, in correspondence with the setting of the first process speed, counts an image clock corresponding to the reference clock to detect the first timing, and forcibly causes the light emission means to emit light at a first period to generate the horizontal sync signal at the first period, and sets a second timing, which is prepared in advance, in correspondence with the setting of the second process speed, counts the image clock corresponding to the reference clock to detect the second timing, and forcibly causes the light emission means to emit light at a second period to generate the horizontal sync signal at the second period.

5. An apparatus according to claim 1, which further comprises light amount detection means for detecting a light amount of the light beam emitted by the light emission means and scanned by the scanning control means, and
in which the first light emission control means detects a timing, which is prepared in advance, on the basis of the reference clock, forcibly causes the light emission means to emit light, and controls the light amount of the light beam emitted by the light emission means to a predetermined value on the basis of a light amount detection result by the light amount detection means corresponding to the forced light emission.

6. An apparatus according to claim 1, which further comprises light amount detection means for detecting a light amount of the light beam emitted by the light emission means and scanned by the scanning control means, and
in which the first light emission control means counts an image clock corresponding to the reference clock to detect a light amount control start timing and a light amount control end timing, which are prepared in advance, forcibly causes the light emission means to emit light in a period of the detected light amount control start timing and light amount control end timing, and controls the light amount of the light beam emitted by the light emission means to a predetermined value on the basis of a light amount detection result by the light amount detection means corresponding to the forced light emission.

7. An apparatus according to claim 1, wherein the first light emission control means counts an image clock corresponding to the reference clock and synchronized with the horizontal sync signal to detect a timing which is prepared in advance, and controls the light emission timing of the light emission means at the preset timing.
